(19) United States
(12) Patent Application Publication
(10) Pub. No.: US 2024/0187620 A1
(43) Pub. Date: Jun. 6, 2024

(54) TRANSFORM SELECTION THROUGH BLOCK MATCHING

(71) Applicant: Tencent America LLC, Palo Alto, CA (US)

(72) Inventors: Xin ZHAO, San Jose, CA (US); Guichun LI, San Jose, CA (US); Lien-Fei CHEN, Hsinchu (TW); Shan LIU, San Jose, CA (US)

(73) Assignee: Tencent America LLC, Palo Alto, CA (US)

(21) Appl. No.: 18/381,618

(22) Filed: Oct. 18, 2023

Related U.S. Application Data
(60) Provisional application No. 63/417,937, filed on Oct. 20, 2022.

(51) Int. Cl. H04N 19/44; H04N 19/11; H04N 19/176; H04N 19/60

(52) U.S. Cl. CPC H04N 19/44; H04N 19/11; H04N 19/176; H04N 19/60

(57) ABSTRACT

Aspects of the disclosure include methods and apparatuses for video coding. One of the apparatuses includes processing circuitry that receives a coded video bitstream that includes a current picture with a current block coded with one of an intra block copy (IBC) mode and an intra template matching (IntraTMP) mode. The processing circuitry determines one of (i) an intra prediction mode based on reconstructed samples of the current picture and (ii) a content type of the reconstructed samples of the current picture. The processing circuitry determines a transform set for the current block coded with the one of the IBC mode and the IntraTMP mode. The transform set is determined as associated with the one of (i) the determined intra prediction mode and (ii) the determined content type. The processing circuitry performs an inverse transform on the current block according to the determined transform set.

### INCORPORATION BY REFERENCE

The present application claims the benefit of priority to U.S. Provisional Application No. 63/417,937, “Transform Selection Through Block Matching” filed on Oct. 20, 2022, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding includes processing circuitry. The processing circuitry receives a coded video bitstream that includes a current picture with a current block coded with one of an intra block copy (IBC) mode and an intra template matching (IntraTMP) mode. The processing circuitry determines one of (i) an intra prediction mode based on reconstructed samples of the current picture and (ii) a content type of the reconstructed samples of the current picture and determines a transform set for the current block coded with the one of the IBC mode and the IntraTMP mode, the transform set being determined as associated with the one of (i) the determined intra prediction mode and (ii) the determined content type. The processing circuitry performs an inverse transform on the current block according to the determined transform set.

In an example, the reconstructed samples include neighboring reconstructed samples of the current block.

In an example, the processing circuitry calculates frequencies of edge directions of the current block using the neighboring reconstructed samples of the current block and determines the intra prediction mode that is associated with the most frequently used edge direction in the edge directions. In an example, the processing circuitry determines the transform set for the current block that is associated with the determined intra prediction mode.

In an example, the processing circuitry calculates template matching costs between a current template including the neighboring reconstructed samples of the current block and respective templates of the current template that are indicated by candidate intra prediction modes and selects a candidate intra prediction mode of the candidate intra prediction modes that is associated with the least template matching cost in the template matching costs as the determined intra prediction mode. The processing circuitry determines the transform set for the current block that is associated with the determined intra prediction mode.

In an example, the reconstructed samples in the current picture include reconstructed samples of a reference block that is indicated by a block vector of the current block. The processing circuitry calculates frequencies of directions of the reconstructed samples in the reference block and determines the intra prediction mode that is associated with the most frequently used direction in the directions. In an example, the processing circuitry determines the transform set for the current block that is associated with the determined intra prediction mode.

In an example, the processing circuitry determines the content type of one of reconstructed samples of a reference block and neighboring reconstructed samples of the current block. The reference block is indicated by a block vector of the current block. The reconstructed samples in the current picture include the one of the reconstructed samples of the reference block and the neighboring reconstructed samples of the current block. In an example, the processing circuitry determines the transform set for the current block according to whether the determined content type is screen content.

In an example, the processing circuitry determines that the transform set is a first transform set based on the determined content type being the screen content and determines that the transform set is a second transform set based on the determined content type being non-screen content. The second transform set is different from the first transform set.

In an example, the processing circuitry determines a number of color values of the one of the reconstructed samples of the reference block and the neighboring reconstructed samples of the current block. In response to the number of color values being less than a threshold of color values, the processing circuitry determines the content type as the screen content.

In an example, the color values of the one of the reconstructed samples of the reference block and the neighboring reconstructed samples of the current block are associated with a specific color component.

In an example, the color values of the one of the reconstructed samples of the reference block and the neighboring reconstructed samples of the current block are associated with multiple color components.

In an example, the determining the one of (i) the intra prediction mode and (ii) the content type and the determining the transform set are performed only in response to the current block being in an intra slice of the current picture.

In an example, the processing circuitry determines the transform set for the current block according to the determined intra prediction mode using a look-up table that maps intra prediction modes to transform sets.

In an example, the transform set for the current block is a secondary transform set and the mapping between the intra prediction modes indicated by mode numbers (IntraPredMode) and the transform sets including 4 low-frequency non-separable transform (LFNST) sets indicated by LFNST set indices 0 to 3 is shown in the look-up table below:

| IntraPredMode | LFNST set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

In an aspect, the processing circuitry receives a coded video bitstream that includes a current picture with a current block coded with one of an intra block copy (IBC) mode and an intra template matching (IntraTMP) mode. The processing circuitry determines an intra prediction mode associated with a reference block of the current block. The reference block is indicated by a block vector (BV) of the current block. The processing circuitry determines a transform set for the current block coded with the one of the IBC mode and the IntraTMP mode according to the intra prediction mode associated with the reference block and performs an inverse transform on the current block according to the determined transform set.

In an example, the processing circuitry obtains prediction mode information associated with at least one subblock in the reference block by checking the at least one subblock in a pre-defined order and determines the intra prediction mode associated with the reference block according to the prediction mode information associated with the at least one subblock.

In an example, the processing circuitry obtains prediction mode information associated with at least one subblock in the reference block that is located at one or more predefined subblock positions and determines the intra prediction mode associated with the reference block according to the prediction mode information associated with the at least one subblock.

In an aspect, the processing circuitry receives a coded video bitstream that includes a current picture with a current block coded with an inter prediction mode. The processing circuitry determines an intra prediction mode associated with a reference block of the current block that is indicated by a motion vector (MV) of the current block. At least a portion of the reference block is intra coded. The processing circuitry determines a transform set for the current block according to the intra prediction mode associated with the reference block and performs an inverse transform on the current block according to the determined transform set.

In an example, the processing circuitry obtains prediction mode information associated with at least one subblock in the reference block by checking the subblocks in a pre-defined order and determines the intra prediction mode associated with the reference block according to the prediction mode information associated with the at least one subblock.

In an example, samples in subblocks in the reference block are coded in different intra prediction modes. The processing circuitry applies filtering to the subblocks to determine the intra prediction mode.

In an example, the processing circuitry obtains prediction mode information associated with at least one subblock in the reference block that is located at one or more predefined subblock positions and determines the intra prediction mode associated with the reference block according to the prediction mode information associated with the at least one subblock.

Aspects of the disclosure also provide a non-transitory computer-readable medium storing instructions which, when executed by a computer, cause the computer to perform the method for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows examples of an intra block copy (IBC) mode according to examples of the disclosure.

FIG. 5 illustrates a reference area for the IBC mode in some examples.

FIG. 6 shows an example of an intra template matching prediction (IntraTMP) mode according to an aspect of the disclosure.

FIG. 7 shows an example of template-based intra mode derivation (TIMD).

FIG. 8 shows an example of a decoder-side intra mode derivation (DIMD).

FIG. 9A shows an example of a transform coding process using a 16×64 transform.

FIG. 9B shows an exemplary mapping from intra prediction modes to transform sets according to an aspect of the disclosure.

FIG. 10 shows a flow chart outlining a process according to some aspect of the disclosure.

FIG. 11 shows a flow chart outlining a process according to some aspect of the disclosure.

FIG. 12 shows a flow chart outlining a process according to some aspect of the disclosure.

FIG. 13 shows a flow chart outlining a process according to some aspect of the disclosure.

FIG. 14 shows a flow chart outlining a process according to some aspect of the disclosure.

FIG. 15 shows a flow chart outlining a process according to some aspect of the disclosure.

FIG. 16 is a schematic illustration of a computer system in accordance with an aspect.

### DETAILED DESCRIPTION OF ASPECTS

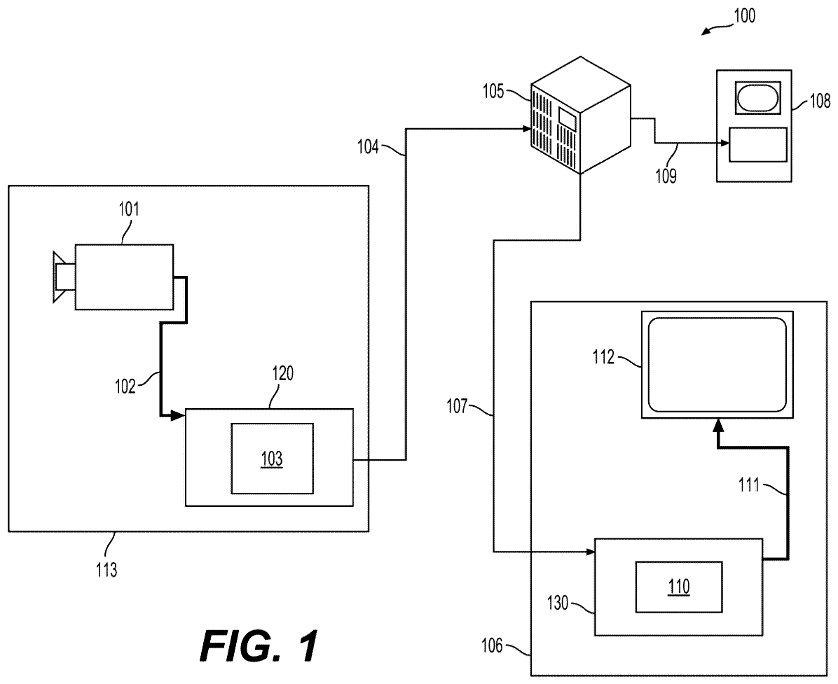

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

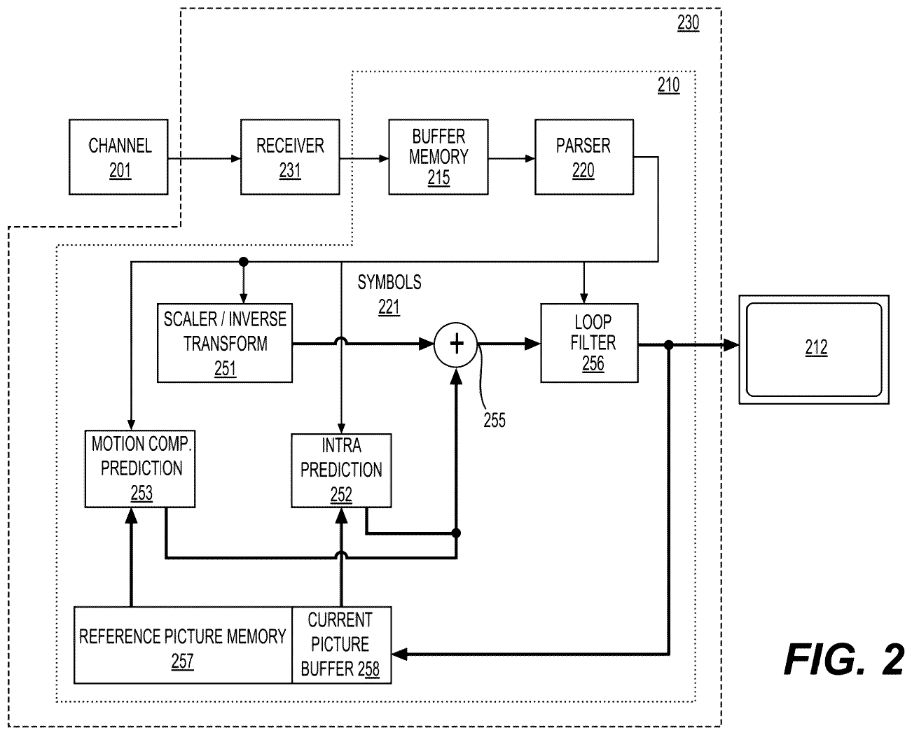

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

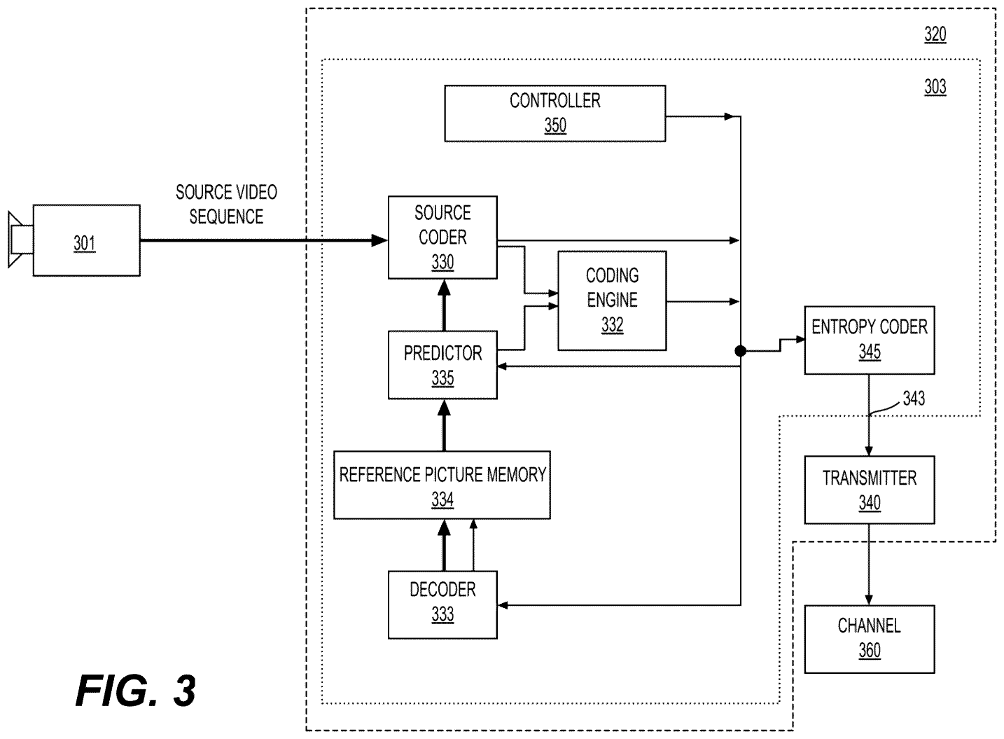

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Examples of an intra block copy mode (also referred to as an IntraBC mode or an IBC mode), such as used in HEVC and VVC, are described below.

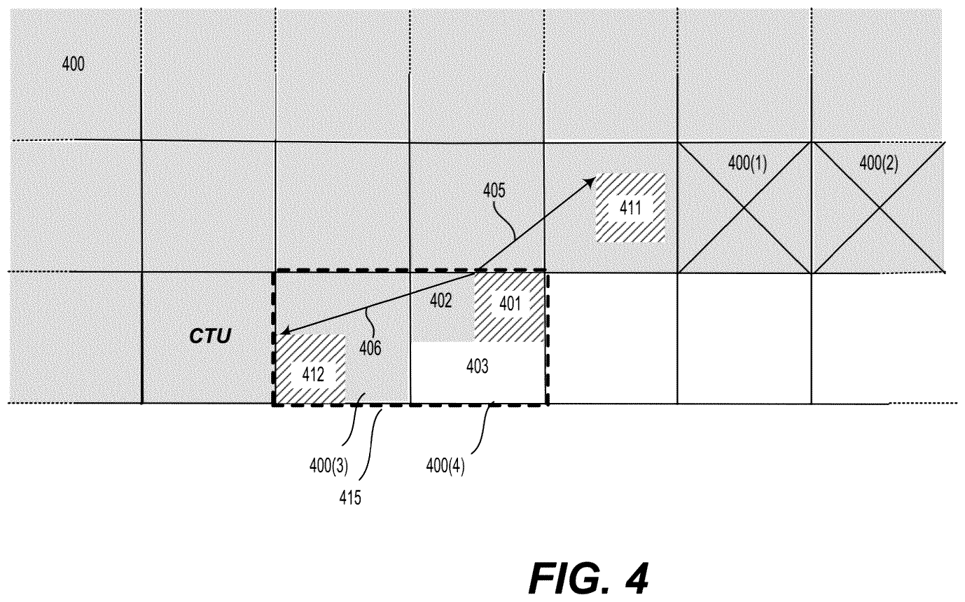

FIG. 4 shows examples of the IBC mode according to examples of the disclosure. A reference block used to predict a current CU (401) can be indicated by a block vector (BV) associated with the current CU (401). Each square (400) can represent a CTU. A gray-shaded area represents an already coded area or an already coded region, and a white, non-shaded area represents an area or a region to be coded. A current CTU (400(4)) that is under reconstruction includes the current CU (401), a coded area (402), and an area (403) to be coded. In an example, the area (403) will be coded after coding the current CU (401).

In an example, such as in HEVC, the gray-shaded area except for the two CTUs (400(1)-400(2)) that are on the right above the current CTU (400(4)) can be used as a reference area in the IBC mode to allow a Wavefront Parallel Processing (WPP). A BV that is allowed in HEVC can point to a block that is within the reference area (e.g., the gray-shaded area excluding the two CTUs (400(1)-400(2))). For example, a BV (405) that is allowed in HEVC points to a reference block (411).

In an example, such as in VVC, in addition to the current CTU (400(4)), only a left neighboring CTU (400(3)) to the left of the current CTU (400(4)) is allowed as a reference area in the IBC mode. In an example, the reference area used in the IBC mode in VVC is within a dotted area (415) and includes samples that are coded. For example, a BV (406) that is allowed in VVC points to a reference block (412).

In BV coding of the IBC mode, referencing to a reconstructed area can be performed via a 2D BV which is similar to an MV used in the inter prediction. Prediction and coding of a BV can reuse MV prediction and coding in the inter prediction process. In some examples, a luma BV is in an integer resolution rather than a ¼-th (or ¼-pel) precision of a MV as used for a regular inter coded CTU.

In an example, a decoded motion vector difference (MVD) or block vector difference (BVD) of a BV is left-shifted (e.g., by two) before being added to a BV predictor to determine the final BV.

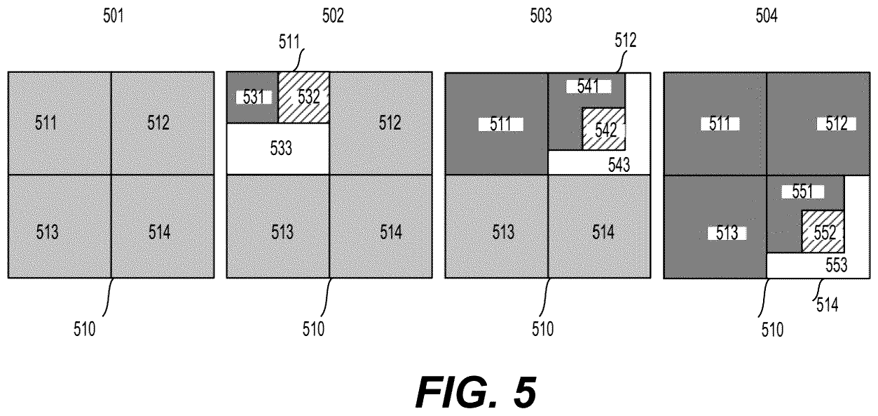

The effective reference area for the IBC mode in some examples, such as the HEVC SCC extensions, is almost the whole already reconstructed area of the current picture, with some exceptions for parallel processing purposes. FIG. 5 illustrates the reference area for the IBC mode in some examples, such as in HEVC and the configuration in VVC, where only the CTU to the left of the current CTU serves as the reference sample area at the beginning of the reconstruction process of the current CTU. A drawback of the IBC concept in some implementations, such as in HEVC, is the requirement of additional memory in a decoded picture buffer (DPB), for which hardware implementation may employ external memory. Additional access to external memory comes with an increased memory bandwidth, making the concept of using the DPB less attractive. Some implementations, such as VVC, use a fixed memory that can realize the IBC mode by using on-chip memory to significantly decrease the memory bandwidth requirement and hardware complexity. In an embodiment, a significant modification addresses the signaling concept departed from the integration within the inter prediction process such as in the HEVC SCC extensions.

FIG. 5 shows a reference sample memory (RSM) (510) update process at four intermediate times (501)-(504) during a reconstruction process according to an embodiment of the disclosure. A light-gray shaded area can represent reference samples of a left neighboring CTU. A dark-gray shaded area can represent reference samples of a current CTU. A white and unshaded area can represent a region to be coded (e.g., upcoming coding areas).

Referring to FIG. 5, at the first intermediate time (501) that represents the beginning of the current CTU reconstruction, in an example, the RSM (510) includes the reference samples of the left neighboring CTU only. In the other three intermediate times (502)-(504), the reconstruction process has replaced samples of the left neighboring CTU with the current CTU's variants. An implicit division of the RSM (510) can be applied and the RSM (510) can be divided into four disjoint 64×64 areas (511)-(514). A reset of an area can occur when the coder processes the first coding unit that would lie in the corresponding area when mapping the RSM to the CTU, easing the hardware implementation efforts.

In examples shown in FIG. 5, a fixed memory (e.g., the RSM (510)) can be allocated to store a reference area used in the IBC mode. A portion of the RSM can be updated at different intermediate times (e.g., (501)-(504)) during a coding process (e.g., an encoding process or a reconstruction process). FIG. 5 shows reference areas for the IBC mode in VVC and configurations in VVC.

Referring to FIG. 5, the RSM (510) can include a portion of the current CTU and/or a portion of the left neighboring CTU. In the examples shown in FIG. 5, a size of the RSM is equal to a size of the CTU. The RSM (510) can include portions (511)-(514).

At the first intermediate time (501) of the coding process, the RSM (510) includes the entire left neighboring CTU that can serve as the reference area in the IBC mode at the beginning of the coding process of the current CTU and does not include the current CTU, and the portions (511)-(514) include the reconstructed samples of the left neighboring CTU.

At the second intermediate time (502) of the coding process of the current CTU, a sub-area (531) of a top-left region in the current CTU is already coded (e.g., encoded or reconstructed), a sub-area (532) of the top-left region in the current CTU is a current CU that is being coded, and a sub-area (533) of the top-left region in the current CTU is to be coded subsequently. The RSM (510) is updated to include a portion of the left neighboring CTU and a portion of the current CTU. For example, the portions (512)-(514) in the RSM (510) store the same reconstructed samples in the left neighboring CTU as the first intermediate time (501) while the portion (511) is updated to store the sub-area (531) of the current CTU. The reference area at the second intermediate time (502) can include the reconstructed samples of the left neighboring CTU stored in the portions (512)-(514) and the reconstructed samples of the sub-area (531) of the current CTU stored in the portion (511).

At the third intermediate time (503) of the coding process of the current CTU, the top-left region of the current CTU is already reconstructed. A top-right region of the current CTU includes sub-areas (541)-(543). The sub-area (541) (in dark-gray shading) is already coded (e.g., encoded or reconstructed), the sub-area (542) is a current CU that is being coded (e.g., being encoded or under reconstruction), and the sub-area (543) (in white color and unshaded) is to be coded subsequently. The portions (513)-(514) in the RSM (510) store the same reconstructed samples in the left neighboring CTU as the first intermediate time (501) while the portions (511)-(512) are updated such that the portion (511) store the reconstructed samples of the top-left region of the current CTU and the portion (512) stores the sub-area (541) of the current CTU. The reference area at the third intermediate time (503) can include (i) the reconstructed samples of the left neighboring CTU stored in the portions (513)-(514) and (ii) the reconstructed samples of the top-left region of the current CTU stored in the portion (511) and the sub-area (541) of the current CTU stored in the portion (512).

At the fourth intermediate time (504) of the coding process of the current CTU, the top-left region, the top-right region, and a bottom-left region of the current CTU are already reconstructed. A bottom-right region of the current CTU includes sub-areas (551)-(553). The sub-area (551) (in dark-gray shading) is already coded (e.g., encoded or reconstructed), the sub-area (552) is a current CU that is being coded (e.g., being encoded or under reconstruction), and the sub-area (553) (in white color and unshaded) is to be coded subsequently. The portion (511) stores the same reconstructed samples of the top-left region in the current CTU as the third intermediate time (503) while the portions (512)-(514) are updated such that the portions (512)-(513) store the reconstructed samples of the top-right region and the bottom-left region of the current CTU, respectively and the portion (514) stores the sub-area (551) of the current CTU. The reference area at the fourth intermediate time (504) can include the reconstructed samples of the current CTU stored in the portions (511)-(514). The RSM (510) at the fourth intermediate time (504) includes no areas in the left neighboring CTU.

The BV coding of the IBC mode can employ the concept of a merge list used for inter prediction. The IBC list construction process can consider two spatial neighbor's BVs and five history-based BVs (HBVP). In an example, only the first HBVP is compared with spatial candidates when added to the candidate list. While the regular inter prediction uses two different candidate lists, one candidate list for the merge mode and the other candidate list for the regular mode, the candidate list in the IBC mode is used for both cases (e.g., including the IBC merge mode and the IBC regular mode). The IBC mode can include different modes, such as the IBC merge mode and the IBC regular mode. The merge mode (e.g., the IBC merge mode) may use up to six candidates of the list, whereas the regular mode (e.g., the IBC regular mode) uses only the first two candidates. The block vector difference (BVD) coding can employ the motion vector difference (MVD) process, resulting in a final BV of any magnitude. The reconstructed BV may point to an area outside of the reference sample area, and in some examples, require a correction by removing an absolute offset for each direction using a modulo operation with the RSM's width and height.

Syntax and Semantics of the IBC mode in some examples, such as in VVC, are described below. The IBC architecture in VVC can form a dedicated coding mode, where the IBC mode is the third prediction mode besides the intra and inter prediction modes. In an example, the bitstream carries the IBC syntax element indicating the IBC mode for a coding unit when the block size is 64×64 or less. Consequently, the largest CU size that can utilize the IBC mode can be 64×64 to realize the continuous memory update mechanism of the RSM. In an example, the reference sample addressing mechanism is the same as in the HEVC SCC extensions by denoting a two-dimensional offset and reusing the inter prediction's vector coding processes. In an example, when the chroma separate tree (CST) is active, where the coder cannot derive chroma BVs from the luma BVs, the usage of the IBC mode is for the luma coding block only.

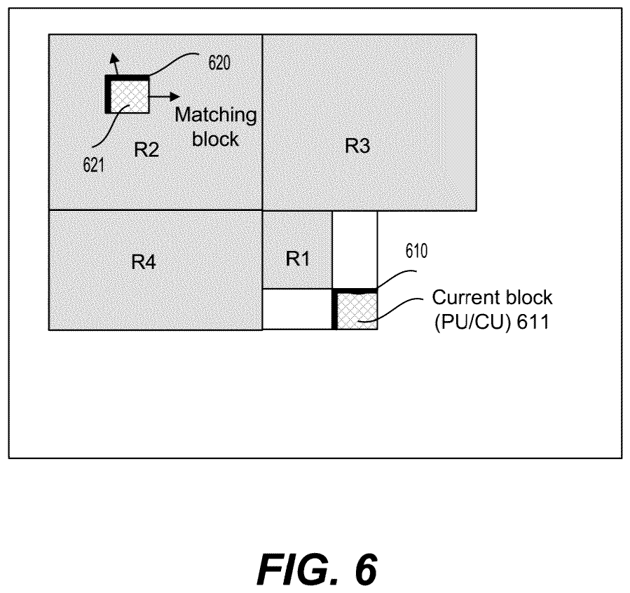

FIG. 6 shows an example of an intra template matching prediction (IntraTMP) mode according to an aspect of the disclosure. In an aspect, such as in Enhanced Compression Model (ECM) software, the IntraTMP is a special intra prediction mode that can copy the best prediction block (e.g., a matching block (621)) from a reconstructed part of a current frame (or a current picture), where a template (e.g., an L-shaped template) (620) of the best prediction block can match a current template (610) of a current block (611) (e.g., a current PU or a current CU). For a predefined search range, an encoder can search for the most similar template to the current template in the reconstructed part of the current frame and can use the corresponding block as a prediction block. The encoder can signal the usage of the IntraTMP mode, and the same prediction operation can be performed at the decoder side.

The prediction signal can be generated by matching the current template (610), such as an L-shaped causal neighbor of the current block (611), with a template of another block in a predefined search area. An exemplary search area shown in FIG. 6 can include multiple CTUs (or superblocks). Referring to FIG. 6, the search area can include a current CTU R1 (e.g., a portion of the current CTU R1), a top-left CTU R2, an above CTU R3, and a left CTU R4. The cost function can include any suitable cost function, such as a sum of absolute differences (SAD).

Within each region, the decoder can search for a template that has the least cost (e.g., the least SAD) with respect to the current template and can use a block associated with the template having the least cost as a prediction block.

Dimensions of regions indicated by (SearchRange w, SearchRange h) can be set to be proportional to a block dimension (BlkW, BlkH) to have a fixed number of SAD comparisons per pixel. Thus,

SearchRange_w=a×BlkW Eq. (1)

SearchRange_h=a×BlkH Eq. (2)

The parameter ‘a’ can be a constant that controls the trade-off between the gain and the complexity. In an example, ‘a’ is 5.

The Intra template matching tool can be enabled for CUs with certain sizes, such as sizes less than or equal to 64 in width and height. The maximum CU size for the IntraTMP mode can be configurable. The IntraTMP mode can be signaled, for example, at a CU level through a dedicated flag when decoder-side intra mode derivation (DIMD) is not used for a current CU.

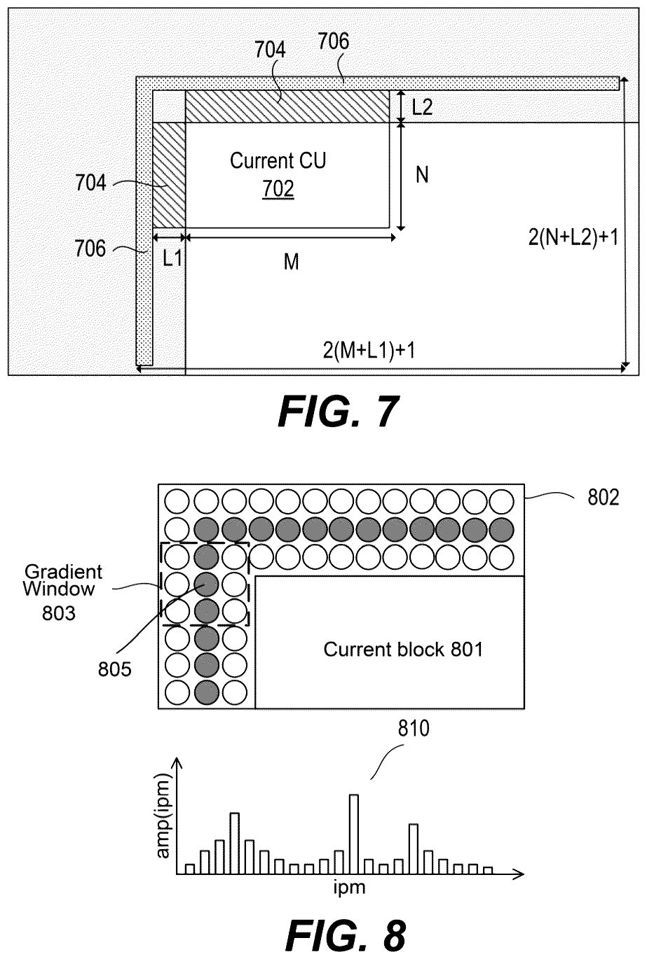

Template-based intra mode derivation (TIMD) can use reference samples of a current CU as a template and select an intra mode among a set of candidate intra prediction modes that is associated with TIMD. The selected intra mode may be determined as a best intra mode based on a cost function, for example. As shown in FIG. 7, neighboring reconstructed samples of the current CU (702) can be used as a template (704). Reconstructed samples in the template (704) can be compared with prediction samples of the template (704). The prediction samples can be generated using reference samples (706) of the template (704). The reference samples (706) can be neighboring reconstructed samples around the template (704). A cost function can be used to calculate a cost (or distortion) between the prediction samples and the reconstructed samples in the template (704) based on a respective one of the set of candidate intra prediction modes. An intra prediction mode with a minimum cost (or distortion) can be selected as the intra prediction mode (e.g., best intra prediction mode) to intra predict the current CU (702).

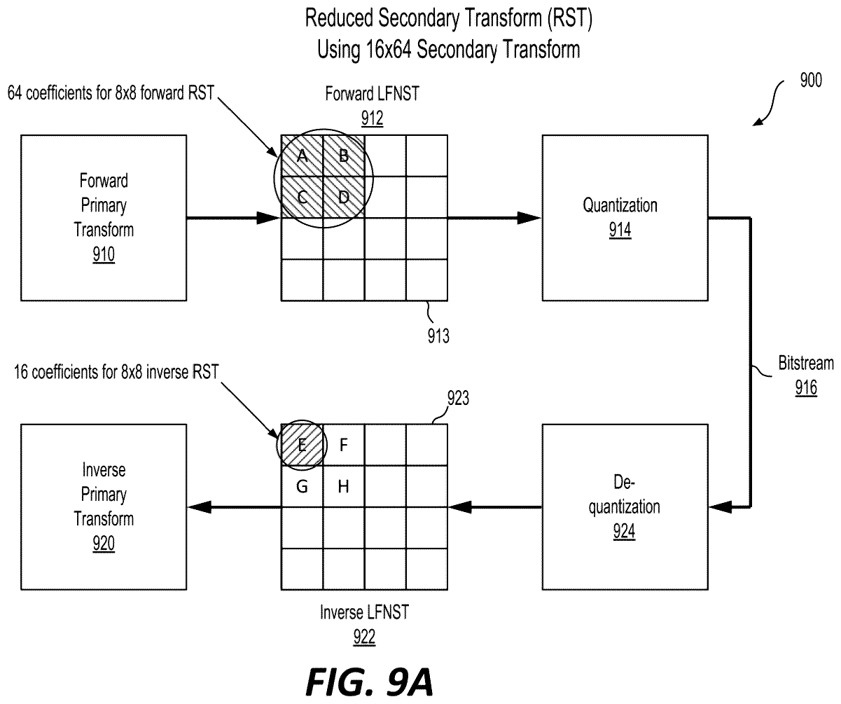

When a decoder-side intra mode derivation (DIMD) is applied, N intra modes can be derived from reconstructed neighbor samples around a current block (801), and the N predictors obtained using the N intra modes can be combined with the planar mode predictor with corresponding weights. The weights can be derived from gradients, such as a histogram of gradient (HoG) computation. FIG. 8 shows an example of the DIMD. The HoG computation can be carried out by applying filters (e.g., horizontal and vertical Sobel filters) on pixels in a template (802) around the current block (801). The template (802) can include reconstructed neighbor samples around the current block (801). In an example, the template has a width of 3. In an example, pixels (marked in gray) in the middle line of the template (802) can be involved in the HoG computation. Referring to FIG. 8, a window (803) around a pixel (805) can be used to determine a gradient associated with the pixel (805). The window (803) can have a size of 3×3 with the pixel (805) in the center of the window (803). A horizontal gradient and a vertical gradient can be obtained using, for example, horizontal and vertical Sobel filters, respectively. A direction or an orientation can be obtained from the horizontal gradient and the vertical gradient. An intra prediction mode (IPM) associated with the direction can be determined. Subsequently, a histogram of IPMs (also referred to as a HoG) (810) can be obtained. The IPMs corresponding to N tallest histogram bars can be selected for the current block (801).

A transform, such as a primary transform, a secondary transform, can be applied to a block. In an example, a transform includes a combination of a primary transform and a secondary transform. In an example, a transform includes a non-separable transform. In an example, a transform includes a separable transform.

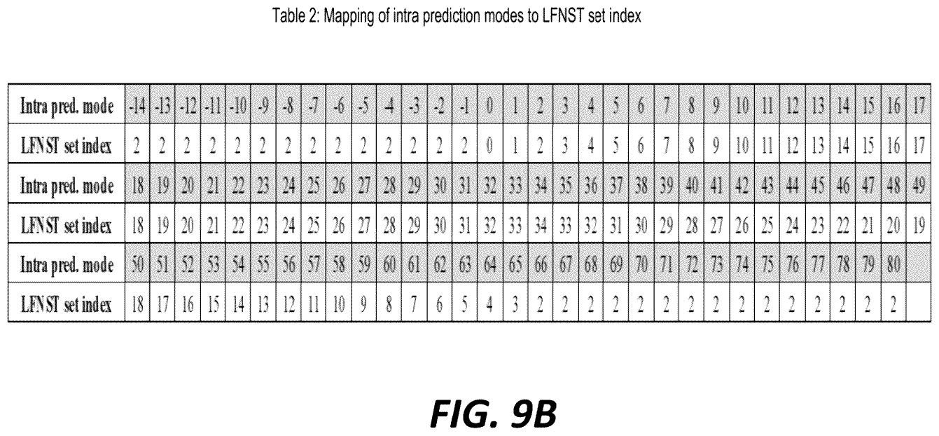

A secondary transform can be performed such as in VVC. In some examples, such as in VVC, a low-frequency non-separable transform (LFNST) can be applied between a forward primary transform and quantization at an encoder side and between de-quantization and an inverse primary transform at a decoder side as shown in FIG. 9A. A reduced secondary transform (RST) method can be used in the LFNST.

Application of a non-separable transform, which can be used in an LFNST, can be described as follows using a 4×4 input block (or an input matrix) X as an example (shown in Eq. (3)). To apply the 4×4 non-separable transform (e.g., the LFNST), the 4×4 input block X can be represented by a vector [symbol] , as shown in Eqs. 3-4.

$$\\ \begin{matrix}X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] & Eq . ( 3 )\end{matrix}$$

$$\\ \begin{matrix}\vec{X} = {[ {X}_{00} {X}_{01} {X}_{02} {X}_{03} {X}_{10} {X}_{11} {X}_{12} {X}_{13} {X}_{20} {X}_{21} {X}_{22} {X}_{23} {X}_{30} {X}_{31} {X}_{32} {X}_{33} ]}^{T} & Eq . ( 4 )\end{matrix}$$

The non-separable transform can be calculated as [symbol] =T· [symbol] , where [symbol] indicates a transform coefficient vector, and T is a 16×16 transform matrix. The 16×1 coefficient vector [symbol] can be subsequently reorganized into a 4×4 output block (or an output matrix, a coefficient block) using a scanning order (e.g., a horizontal scanning order, a vertical scanning order, a zigzag scanning order, or a diagonal scanning order) for the 4×4 input block. The transform coefficients with smaller indices can be placed with smaller scanning indices in the 4×4 coefficient block.

FIG. 9A shows an example of a transform coding process (900) using a 16×64 transform (or a 64×16 transform depending on whether the transform is a forward or inverse secondary transform). Referring to FIG. 9A, in the process (900), at an encoder side, a forward primary transform (910) can first be performed over a block (e.g., a residual block) to obtain a coefficient block (913). Subsequently, a forward secondary transform (or a forward LFNST) (912) can be applied to the coefficient block (913). In the forward secondary transform (912), 64 coefficients of 4×4 sub-blocks A-D at a top-left corner of the coefficient block (913) can be represented by a 64-length vector, and the 64-length vector can be multiplied with a transform matrix of 64×16 (i.e., a width of 64 and a height of 16), resulting in a 16-length vector. Elements in the 16-length vector are filled back into the top-left 4×4 sub-block A of the coefficient block (913). The coefficients in the sub-blocks B-D can be zero. The resulting coefficients after the forward secondary transform (912) are then quantized at a quantization step (914), and entropy-coded to generate coded bits in a bitstream (916).

The coded bits can be received at a decoder side, and entropy-decoded followed by a de-quantization step (924) to generate a coefficient block (923). An inverse secondary transform (or an inverse LFNST) (922), such as an inverse RST8×8, can be performed to obtain 64 coefficients, for example, from the 16 coefficients at a top-left 4×4 sub-block E. The 64 coefficients can be filled back to the 4×4 sub-blocks E-H. Further, the coefficients in the coefficient block (923) after the inverse secondary transform (922) can be processed with an inverse primary transform (920) to obtain a recovered residual block.

In an example, a 4×4 non-separable transform (e.g., a 4×4 LFNST) or an 8×8 non-separable transform (e.g., an 8×8 LFNST) is applied according to a block size of the block. The block size of the block can include a width, a height, or the like. For example, the 4×4 LFNST is applied for the block where a minimum of the width and the height is less than a threshold, such as 8 (e.g., min (the width, the height)<8). For example, the 8×8 LFNST is applied for the block where the minimum of the width and the height is larger than a threshold, such as 4 (e.g., min (width, height)>4).

A non-separable transform (e.g., the LFNST) can be based on a direct matrix multiplication approach, and thus can be implemented in a single pass without iteration. To reduce a non-separable transform matrix dimension and to minimize computational complexity and memory space to store transform coefficients, a reduced non-separable transform method (or RST) can be used in the LFNST. Accordingly, in the reduced non-separable transform, an N (e.g., N is 64 for an 8×8 non-separable secondary transform (NSST)) dimensional vector can be mapped to an R dimensional vector in a different space, where N/R (R<N) is a reduction factor. Hence, instead of an N×N matrix, an RST matrix is an R×N matrix as described in Eq. (5).

$$\\ \begin{matrix}{T}_{R \times N} = [ \begin{matrix}{t}_{11} & {t}_{12} & {t}_{13} & & {t}_{1 N} \\ {t}_{21} & {t}_{22} & {t}_{23} & ⋯ & {t}_{2 N} \\ & ⋮ & & ⋱ & ⋮ \\ {t}_{R 1} & {t}_{R 2} & {t}_{R 3} & ⋯ & {t}_{R N}\end{matrix} ] & Eq . ( 5 )\end{matrix}$$

In Eq. (5), R rows of the R×N transform matrix are R bases of the N dimensional space. The inverse transform matrix can be a transpose of the transform matrix (e.g., T_{R×N}) used in the forward transform. For an 8×8 LFNST, a reduction factor of 4 can be applied, and a 64×64 direct matrix used in an 8×8 non-separable transform can be reduced to a 16×64 direct matrix, as shown in FIG. 9A. Alternatively, a reduction factor larger than 4 can be applied, and the 64×64 direct matrix used in the 8×8 non-separable transform can be reduced to a 16×48 direct matrix. Hence, a 48×16 inverse RST matrix can be used at a decoder side to generate core (primary) transform coefficients in an 8×8 top-left region.

When the 16×48 matrix is applied instead of the 16×64 matrix with a same transform set configuration, an input to the 16×48 matrix includes 48 input data from three 4×4 blocks A, B, and C in a top-left 8×8 block excluding a right-bottom 4×4 block D. With a reduction in the dimension, a memory usage for storing LFNST matrices can be reduced, for example, from 10 KB to 8 KB with a minimal performance drop.

In order to reduce complexity, the LFNST can be restricted to be applicable if coefficients outside a first coefficient subgroup are non-significant. In an example, the LFNST can be restricted to be applicable only if all coefficients outside the first coefficient subgroup are non-significant. Referring to FIG. 9A, the first coefficient subgroup corresponds to the top-left block E, and thus the coefficients that are outside the block E are non-significant.

In an example, primary-only transform coefficients are non-significant (e.g., zero) when the LFNST is applied. In an example, all primary-only transform coefficients are zero when the LFNST is applied. The primary-only transform coefficients can refer to transform coefficients that are obtained from a primary transform without a secondary transform.

Accordingly, an LFNST index signaling can be conditioned on a last-significant position, and thus avoiding an extra coefficient scanning in the LFNST. In some examples, the extra coefficient scanning is used to check significant transform coefficients at specific positions. In an example, the worst-case handling of the LFNST, for example, in terms of multiplications per pixel restricts the non-separable transform for a 4×4 block and an 8×8 block to an 8×16 transform and an 8×48 transform, respectively. In the above cases, the last-significant scan position can be less than 8 when the LFNST is applied. For other sizes, the last-significant scan position can be less than 16 when the LFNST is applied. For a block of 4×N and N×4 and N is larger than 8, the restriction can imply that the LFNST is applied to a top-left 4×4 region in the block. In an example, the restriction implies that the LFNST is applied only once to the top-left 4×4 region only in the block. In an example, all the primary-only coefficients are non-significant (e.g., zero) when the LFNST is applied, a number of operations for the primary transform is reduced. From an encoder perspective, quantization of transform coefficients can be significantly simplified when the LFNST transform is tested. A rate-distortion optimized quantization can be done at maximum for the first 16 coefficients, for example, in a scanning order, remaining coefficients can be set to zero.

An LFNST transform (also referred to as a transform kernel, a transform core, or a transform matrix) can be selected as described below. In an embodiment, multiple transform sets can be used, and one or more non-separable transform matrices (or kernels) can be included in each of the multiple transform sets in the LFNST. A transform set can be selected from the multiple transform sets, and a non-separable transform matrix can be selected from the one or more non-separable transform matrices in the transform set.

Table 1 shows an exemplary mapping from intra prediction modes to the multiple transform sets according to an embodiment of the disclosure. The mapping indicates a relationship between the intra prediction modes and the multiple transform sets. The relationship, such as indicated in Table 1, can be pre-defined and can be stored in an encoder and a decoder.

TABLE 1
Transform set selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

Referring to Table 1, the multiple transform sets include four transform sets, e.g., transform sets 0 to 3 represented by a transform set index (e.g., Tr. set index) from 0 to 3, respectively. An index (e.g., an intra prediction mode index or an IntraPredMode) can indicate the intra prediction mode, and the transform set index can be obtained based on the index and Table 1. Accordingly, the transform set can be determined based on the intra prediction mode. In an example, if one of three cross component linear model (CCLM) modes (e.g., INTRA_LT_CCLM, INTRA_T_CCLM or INTRA_L_CCLM) is used for a current block (e.g., 81<=IntraPredMode<=83), the transform set 0 is selected for the current block.

As described above, each transform set can include the one or more non-separable transform matrices. One of the one or more non-separable transform matrices can be selected by an LFNST index that is, for example, explicitly signaled. The LFNST index can be signaled in a bitstream once per intra-coded CU, for example, after signaling transform coefficients. For each transform set, the selected non-separable secondary transform candidate can be specified by the explicitly signaled LFNST index.

In an embodiment, the LFNST is restricted to be applicable only if all coefficients outside the first coefficient subgroup are non-significant, coding of the LFNST index can depend on a position of the last significant coefficient. The LFNST index can be context coded. In an example, the context coding of the LFNST index does not depend on an intra prediction mode, and only a first bin is context coded. The LFNST can be applied to an intra-coded CU in an intra slice or in an inter slice, and for both Luma and Chroma components. If a dual tree is enabled, LFNST indices for Luma and Chroma components can be signaled separately. For an inter slice (e.g., the dual tree is disabled), a single LFNST index can be signaled and used for both the Luma and Chroma components.

Considering that a large CU greater than 64×64 is implicitly split (TU tiling) due to the existing maximum transform size restriction (e.g., 64×64), an LFNST index search can increase data buffering by four times for a certain number of decode pipeline stages. Therefore, in some examples, the maximum size that the LFNST is allowed is restricted to 64×64. In an example, the LFNST is enabled with DCT2 only. In an example, the LFNST index signaling is placed before an MTS index signaling.

In an example, the use of scaling matrices for perceptual quantization is not evident that the scaling matrices that are specified for the primary matrices may be useful for LFNST coefficients. Hence, in some examples, the uses of the scaling matrices for LFNST coefficients are not allowed. In an example, for a single-tree partition mode, a chroma LFNST is not applied.

In an aspect, such as in ECM, the LFNST design in VVC is extended as follows:
The number of LFNST sets (S) and candidates (C) are extended to S=35 and C=3, and the LFNST set (lfnstTrSetIdx) for a given intra mode (predModeIntra) is derived according to the following formula:

For predModeIntra<0, lfnstTrSetIdx is equal to 2

lfnstTrSetIdx=predModeIntra, for predModeIntra in [0,34]

lfnstTrSetIdx=68−predModeIntra, for predModeIntra in [35,66]

Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

FIG. 9B shows an example of the mapping from intra prediction modes to these sets according to an aspect of the disclosure. As shown in FIG. 9B, a table, such as Table 2, is used to indicate the mapping from the intra prediction modes (denoted as Intra pred. mode in Table 2) to the secondary transform sets, such as the LFNST sets indicated by respective LFNST set indices (denoted as lfnstTrSetIdx in Table 2).

In related technologies, when applying a transform to IBC coded blocks (e.g., the IntraBC coded blocks) or IntraTMP coded blocks, the same primary and secondary transform set as applied to the Planar intra prediction mode is applied. However, an IntraBC coded block or an IntraTMP coded block may present certain directions in the texture, and thus sharing the same transform set as used for the Planar intra prediction mode may be suboptimal. According to an aspect of the disclosure, the transform selection can be performed through block matching.

A current picture is being coded (e.g., encoded or reconstructed). A current block in the current picture can be coded with one of the IBC mode and the IntraTMP mode. The current block can be referred to as the IBC coded block or the IntraTMP coded block. According to an aspect of the disclosure, a transform set for the current block can be determined (e.g., selected) based on reconstructed samples (also referred to as reconstruction samples) of the current picture. In an example, the reconstructed samples of the current picture includes neighboring reconstructed samples of the current block. In an example, the reconstructed samples of the current picture includes reconstructed samples of a reference block that is indicated by a BV of the current block. The reference block of the current block can also be referred to as a prediction block of the current block. The reconstructed samples of the reference block can also be referred to as the reconstruction samples of the prediction block. For example, the transform set is selected for the current block (e.g., an IntraBC coded block or an IntraTMP coded block) using the reconstruction samples of the prediction block (also referred to as the reference block) or the neighboring reconstruction samples of the current block.

In an example, the transform set for the current block (e.g., the IntraBC coded block or the IntraTMP coded block) may refer to a primary transform set or a secondary transform set. The transform set for the current block can include the primary transform set or the secondary transform set.

In an example, one of (i) an intra prediction mode based on the reconstructed samples of the current picture and (ii) a content type of the reconstructed samples of the current picture is determined. The transform set associated with the one of (i) the determined intra prediction mode and (ii) the determined content type can be determined as the transform set for the current block. In an aspect, the transform set for the current block coded with the one of the IBC mode and the IntraTMP mode is determined as being associated with the one of (i) the determined intra prediction mode and (ii) the determined content type. A transform can be performed on the current block according to the determined transform set. For example, on an encoder side, an inverse transform is performed on the current block according to the determined transform set. In an example, on a decoder side, a forward transform is performed on the current block according to the determined transform set.

In one aspect, when the neighboring reconstruction samples are used to determine the transform set, the DIMD method, for example, a method used in the DIMD mode, is utilized to derive an intra prediction mode to select the transform set, and the intra prediction mode associated with the largest histogram amplitude value is used to determine the transform set. For example, frequencies of edge directions of the current block are calculated using the neighboring reconstructed samples of the current block, such as described in FIG. 8 in the DIMD mode. An edge direction associated with one (e.g., (805)) of the neighboring reconstructed samples of the current block may be calculated using a gradient window (e.g., (803)). In an example, the frequencies of the edge directions of the current block (e.g., a number of times each edge direction occurs) can be plotted in a histogram similar to the histogram (810). A frequency of an edge direction corresponds to a respective histogram amplitude value in the histogram. The intra prediction mode that is associated with the most frequently used edge direction in the edge directions can be determined. The most frequently used edge direction corresponds to the largest histogram amplitude value. The transform set for the current block can be determined as a transform set associated with the determined intra prediction mode, for example, the transform set associated with the determined intra prediction mode (e.g., the intra prediction mode associated with the most frequently used edge direction) can be used as the transform set for the current block. In an example, one or more intra prediction modes are associated with a transform set, such as shown in Table 1 or Table 2. If a block is predicted using one of the one or more intra prediction modes associated with the transform set, a transform in the transform set can be used to transform the block.

In an example, the intra prediction mode determined using the DIMD method described above (e.g., the intra prediction mode that is associated with the most frequently used edge direction in the edge directions) is an angular mode or a directional intra prediction mode.

In one aspect, when the neighboring reconstruction samples are used to determine the transform set, the TIMD method, for example, a template matching method used in the TIMD mode such as shown in FIG. 7, is utilized to derive an intra prediction mode to select the transform set, and the intra prediction mode associated with the least template matching cost can be used to determine the transform set. For example, template matching costs between a current template including the neighboring reconstructed samples of the current block and respective templates of the current template that are indicated by candidate intra prediction modes are calculated, such as shown in FIG. 7. A candidate intra prediction mode of the candidate intra prediction modes that is associated with the least template matching cost in the template matching costs can be selected as the determined intra prediction mode. The transform set for the current block is determined as being associated with the determined intra prediction mode.

In one aspect, when the reconstruction samples of the prediction block (e.g., the reference block) are used to determine the transform set, a direction histogram (also referred to as the edge direction histogram) is derived based on the reconstruction samples of the prediction block using the DIMD method, for example, a method used in the DIMD mode such as described above and in FIG. 8. A direction (referred to as an edge direction) with the largest histogram amplitude value is derived, and the associated intra prediction mode is used to determine the transform set. In an example, the reconstructed samples in the entire reference block are used to determine the direction histogram. In an example, the reconstructed samples that are at the boundaries of the reference block are used to determine the direction histogram, and the direction histogram is referred to as the edge direction histogram. In an example, the derivation of the direction histogram includes calculating frequencies of directions of the reconstructed samples in the reference block. The intra prediction mode that is associated with the most frequently used direction in the directions is determined, and the transform set for the current block is determined as being associated with the determined intra prediction mode. As descried above, the direction with the largest histogram amplitude value is the most frequently used direction.

Intra prediction modes can be related to transform sets. In an aspect, one or more intra prediction modes can be associated with (e.g., mapped to) a distinct transform set, such as shown in Tables 1 and 2.

According to aspect of the disclosure, the transform set for the current block can be determined according to the determined intra prediction mode using a look-up table (e.g., Table 1 or Table 2) that maps intra prediction modes to transform sets.

In one aspect, the methods of the intra prediction mode based transform set selection may be the same as in VVC standard, such as described in Table 1. For example, the transform set for the current block is a secondary transform set. The mapping between the intra prediction modes indicated by mode numbers (IntraPredMode) and the transform sets including 4 LFNST sets indicated by LFNST set indices 0 to 3 are shown in the look-up table, such as Table 1.

In one aspect, the method of the intra prediction mode based transform set selection for a primary transform and a secondary transform may be the same as in ECM. Referring back to FIG. 9B, an intra prediction mode can be mapped into a secondary transform set (e.g., an LFNST transform set) based on the mapping relationship between intra prediction modes (indicated by an intra prediction mode number between −14 to 80) and the LFNST transform sets (indicated by an LFNST set index between 0 to 34) shown in Table 2.

In one aspect, a content type detection on the neighboring reconstruction samples of the current block or the reconstruction samples of the prediction block is performed, and a decision whether the current block is screen content or non-screen content is determined. Based on this content type determination, different transform sets may be applied. For example, the content type of the reconstructed samples of the reference block or the neighboring reconstructed samples of the current block is determined. The transform set for the current block can be determined according to whether the determined content type is screen content. For example, two different transform sets can be applied for the screen content and the non-screen content, respectively. In an example, there is a 1 to 1 correspondence between a transform set and a content type.

In an example, that the transform set is a first transform set is determined based on the determined content type being the screen content. In an example, that the transform set is a second transform set is determined based on the determined content type being non-screen content. The second transform set is different from the first transform set.

In one example, the content type detection process involves checking how many distinct color values in the neighboring reconstruction samples of the current block or the reconstruction samples of the reference block. If there is less than a threshold of color values (e.g., a given threshold of color values), then the content type of the neighboring reconstruction samples of the current block or the reconstruction samples of the reference block is the screen content. For example, a number of color values of the reconstructed samples of the reference block or the neighboring reconstructed samples of the current block is determined. If the number of color values is less than the threshold of color values, the content type is determined as the screen content.

The color values of the reconstructed samples of the reference block or the neighboring reconstructed samples of the current block can be associated with a specific color component. In one example, the color value means the value of one specific color component, e.g., a luma component. In an example, the color value are integers ranging from 0 to 255.

The color values of the reconstructed samples of the reference block or the neighboring reconstructed samples of the current block can be associated with multiple color components. In one example, the color value means the value combination of multiple color components, e.g., a combination of Y, Cb and Cr, or a combination of R, G, and B. A first color value is different from a second color value if a value of the same color component changes. In an example, the color value is the combination of Y, Cb and Cr, a first color value of [100, 10, 5] of Y, Cb and Cr is different from a second color value of [100, 5, 5] of Y, Cb and Cr.

In one aspect, the methods described above may only apply for blocks in an intra slice, for example, when the current block is in an intra slice. For example, the methods that determine the intra prediction mode or the content type and the methods that determine the transform set are performed only when the current block is in an intra slice of the current picture.

According to an aspect of the disclosure, for IntraBC coded blocks or IntraTMP coded blocks, such as the current block that is coded using the IBC mode or the IntraTMP mode, the intra prediction mode associated with the block (e.g., the reference block) identified by the block vector (BV) used in IntraBC/IntraTMP can be used to determine the transform set. In an example, at least a portion of the reference block is intra coded. For example, the intra prediction mode associated with the reference block of the current block is determined. The transform set for the current block can be determined according to the intra prediction mode associated with the reference block.

In one example, the block (e.g., the reference block) identified by the block vector may be checked in unit of subblocks, for example, following a pre-defined order to identify an intra prediction mode. The reference block can include the subblocks. A prediction mode of a first subblock can be different from a prediction mode of a second subblock. Prediction mode information associated with at least one subblock in the reference block can be obtained by checking the at least one subblock, for example, in the pre-defined order. Prediction mode information associated with a subblock can indicate a prediction mode of the subblock. The intra prediction mode associated with the reference block can be determined according to the prediction mode information associated with the at least one subblock. In an example, the intra prediction mode associated with the reference block is the first intra prediction mode identified according to the pre-defined order. In an example, the at least one subblock includes a plurality of subblocks that are coded with respective prediction modes. The prediction modes can include multiple intra prediction modes used to code subblocks (e.g., intra coded subblocks). In an example, the intra prediction mode associated with the reference block is determined as the most frequently used in the multiple intra prediction modes to code the intra coded subblocks.

In another aspect, the reference block identified by the block vector may be checked at one or more predefined subblock positions. For example, prediction mode information associated with at least one subblock in the reference block that is located at one or more predefined subblock positions is obtained. The intra prediction mode associated with the reference block can be determined according to the prediction mode information associated with the at least one subblock that is located at one or more predefined subblock positions.

According to an aspect of the disclosure, for inter coded blocks including an inter coded block, if the motion vector (MV) points to a reference block that at least partial samples in the reference block (or at least a portion of the reference block) are intra coded, then the intra prediction mode associated with the reference block can be used to determine the transform set. The reference block of the inter coded block and the inter coded block can be located in different pictures. In an aspect, the intra prediction mode associated with the reference block of the inter coded block is determined. At least the portion of the reference block can be intra coded. The transform set for the current block can be determined according to the intra prediction mode associated with the reference block. A transform can be performed on the current block according to the determined transform set.

In one aspect, the reference block may be checked in unit of subblocks following a pre-defined order to identify an intra prediction mode. The reference block can include the subblocks. A prediction mode of a first subblock can be different from a prediction mode of a second subblock. Prediction mode information associated with at least one subblock in the reference block can be obtained by checking the at least one subblock, for example, in the pre-defined order. Prediction mode information associated with a subblock can indicate a prediction mode of the subblock. The intra prediction mode associated with the reference block can be determined according to the prediction mode information associated with the at least one subblock. In an example, the intra prediction mode associated with the reference block is the first intra prediction mode identified according to the pre-defined order. In an example, the at least one subblock includes a plurality of subblocks that are coded with respective prediction modes. The prediction modes can include multiple intra prediction modes used to code subblocks (e.g., intra coded subblocks). In an example, the intra prediction mode associated with the reference block is determined as the most frequently used in the multiple intra prediction modes to code the intra coded subblocks.

In another aspect, a filtering may be applied to the unit of subblocks within the reference block of the inter coded block to derive an intra prediction mode when the samples within the reference block are coded in different intra prediction modes.

In another aspect, the reference block identified by the MV may be checked at one or more predefined subblock positions. For example, prediction mode information associated with at least one subblock in the reference block that is located at one or more predefined subblock positions is obtained. The intra prediction mode associated with the reference block can be determined according to the prediction mode information associated with the at least one subblock that is located at one or more predefined subblock positions.

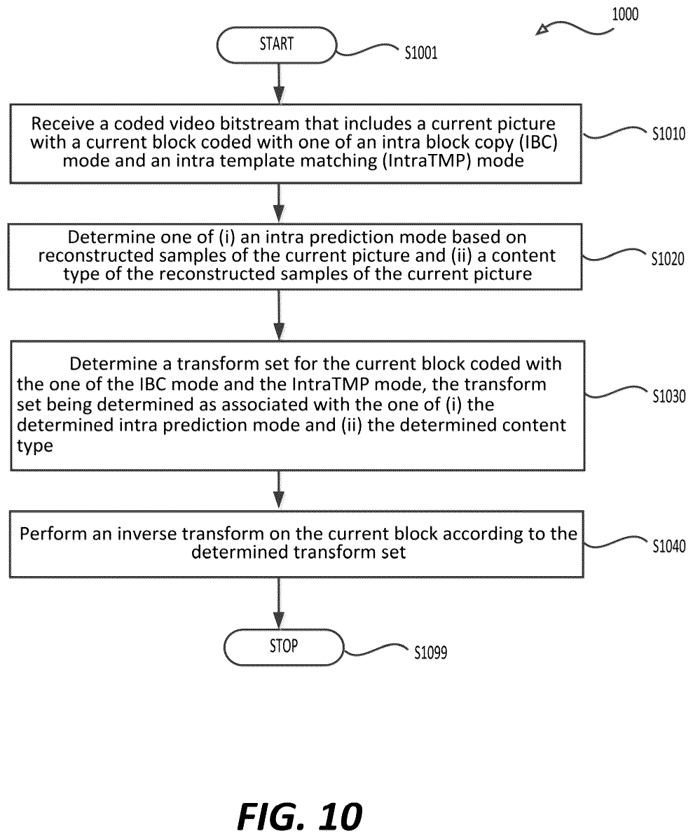

FIG. 10 shows a flow chart outlining a process (1000) according to an aspect of the disclosure. The process (1000) can be used in a video decoder. In various aspects, the process (1000) is executed by processing circuitry, such as the processing circuitry that performs functions of the video decoder (110), the processing circuitry that performs functions of the video decoder (210), and the like. In some aspects, the process (1000) is implemented in software instructions, thus when the processing circuitry executes the software instructions, the processing circuitry performs the process (1000). The process starts at (S1001) and proceeds to (S1010).

At (S1010), a coded video bitstream that includes a current picture with a current block coded with one of an intra block copy (IBC) mode and an intra template matching (IntraTMP) mode is received.

At (S1020), one of (i) an intra prediction mode based on reconstructed samples of the current picture and (ii) a content type of the reconstructed samples of the current picture can be determined.

At (S1030), a transform set for the current block coded with the one of the IBC mode and the IntraTMP mode can be determined. The transform set can be determined as associated with the one of (i) the determined intra prediction mode and (ii) the determined content type.

At (S1040), an inverse transform can be performed on the current block according to the determined transform set.

Then, the process proceeds to (S1099) and terminates.

The process (1000) can be suitably adapted. Step(s) in the process (1000) can be modified and/or omitted. Additional step(s) can be added. Any suitable order of implementation can be used.

In an example, the reconstructed samples include neighboring reconstructed samples of the current block.

In an example, the determining the one of (i) the intra prediction mode and (ii) the content type includes calculating frequencies of edge directions of the current block using the neighboring reconstructed samples of the current block and determining the intra prediction mode that is associated with the most frequently used edge direction in the edge directions, such as described in FIG. 8 with a method used in the DIMD mode. The determining the transform set includes determining the transform set for the current block that is associated with the determined intra prediction mode.

In an example, the determining the one of (i) the intra prediction mode and (ii) the content type includes calculating template matching costs between a current template including the neighboring reconstructed samples of the current block and respective templates of the current template that are indicated by candidate intra prediction modes, and selecting a candidate intra prediction mode of the candidate intra prediction modes that is associated with the least template matching cost in the template matching costs as the determined intra prediction mode. The determining the transform set includes determining the transform set for the current block that is associated with the determined intra prediction mode.

In an example, the reconstructed samples in the current picture include reconstructed samples of a reference block that is indicated by a block vector of the current block. The determining the one of (i) the intra prediction mode and (ii) the content type includes calculating frequencies of directions of the reconstructed samples in the reference block and determining the intra prediction mode that is associated with the most frequently used direction in the directions. The determining the transform set includes determining the transform set for the current block that is associated with the determined intra prediction mode.

In an example, the determining the one of (i) the intra prediction mode and (ii) the content type includes determining the content type of one of reconstructed samples of a reference block and neighboring reconstructed samples of the current block. The reference block is indicated by a block vector of the current block. The reconstructed samples in the current picture include the one of the reconstructed samples of the reference block and the neighboring reconstructed samples of the current block. The determining the transform set includes determining the transform set for the current block according to whether the determined content type is screen content.

In an example, that the transform set is a first transform set is determined based on the determined content type being the screen content. In an example, that the transform set is a second transform set is determined based on the determined content type being non-screen content, the second transform set being different from the first transform set.

In an example, a number of color values of the one of the reconstructed samples of the reference block and the neighboring reconstructed samples of the current block is determined. If the number of color values is less than a threshold of color values, the content type is determined as the screen content. In an example, the color values of the one of the reconstructed samples of the reference block and the neighboring reconstructed samples of the current block are associated with a specific color component. In an example, the color values of the one of the reconstructed samples of the reference block and the neighboring reconstructed samples of the current block are associated with multiple color components.

In an aspect, the determining the one of (i) the intra prediction mode and (ii) the content type and the determining the transform set are performed only in response to the current block being in an intra slice of the current picture.

In an example, the transform set for the current block is determined according to the determined intra prediction mode using a look-up table that maps intra prediction modes to transform sets. In an example, the transform set for the current block is a secondary transform set. The mapping between the intra prediction modes indicated by mode numbers (IntraPredMode) and the transform sets including low-frequency non-separable transform (LFNST) sets indicated by LFNST set indices (e.g., 0 to 3 in Table 1, 0 to 34 in Table 2) is shown in the look-up table, such as Table 1 or Table 2.

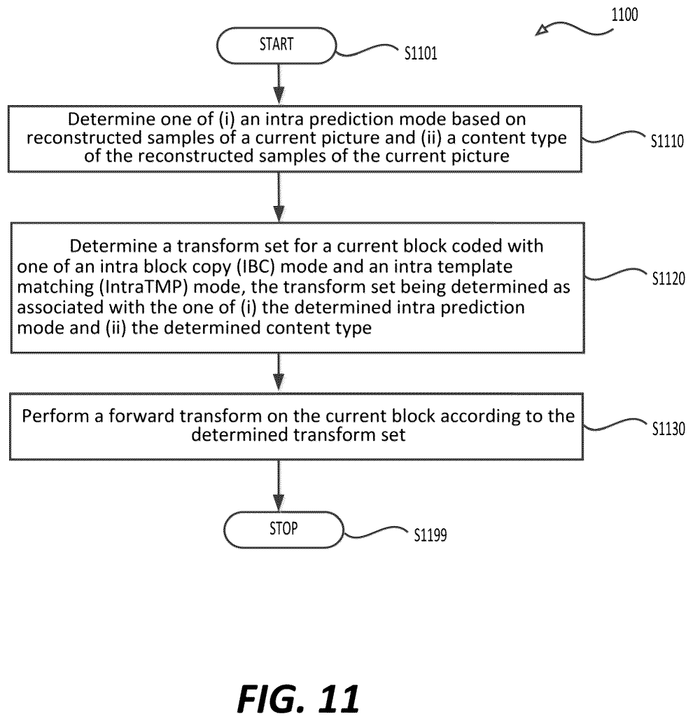

FIG. 11 shows a flow chart outlining a process (1100) according to an aspect of the disclosure. The process (1100) can be used in a video encoder. In various aspects, the process (1100) is executed by processing circuitry, such as the processing circuitry that performs functions of the video encoder (103), the processing circuitry that performs functions of the video encoder (303), and the like. In some aspects, the process (1100) is implemented in software instructions, thus when the processing circuitry executes the software instructions, the processing circuitry performs the process (1100). The process starts at (S1101) and proceeds to (S1110).

At (S1110), (i) an intra prediction mode can be determined based on reconstructed samples of a current picture or (ii) a content type of the reconstructed samples of the current picture can be determined.

At (S1120), a transform set for a current block coded with one of an intra block copy (IBC) mode and an intra template matching (IntraTMP) mode can be determined. The transform set can be determined as being associated with the one of (i) the determined intra prediction mode and (ii) the determined content type, such as a transform set that is associated with the one of (i) the determined intra prediction mode and (ii) the determined content type.

At (S1130), a forward transform can be performed on the current block according to the determined transform set.

Then, the process proceeds to (S1199) and terminates.

The process (1100) can be suitably adapted. Step(s) in the process (1100) can be modified and/or omitted. Additional step(s) can be added. Any suitable order of implementation can be used.

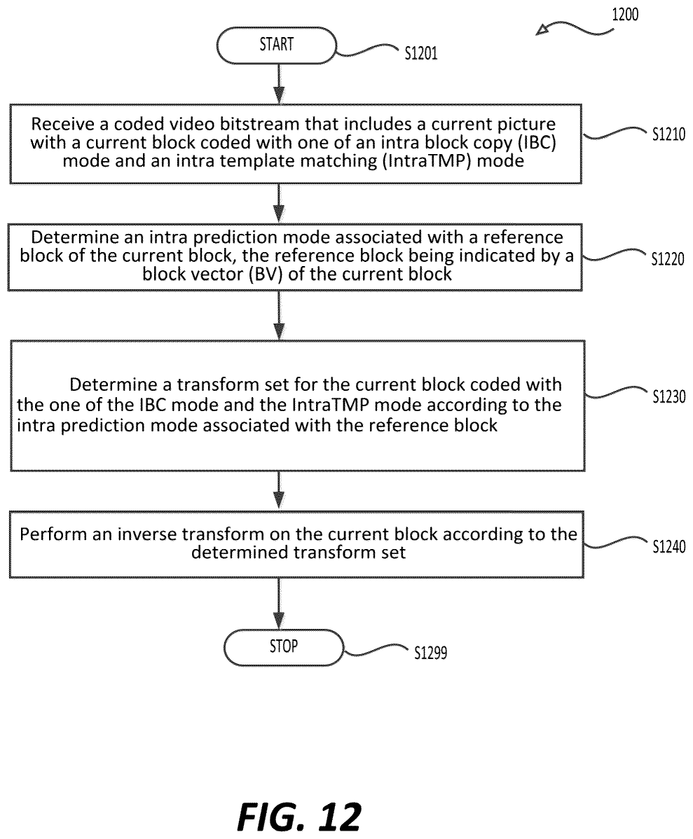

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a coded video bitstream that includes a current picture with a current block coded with one of an intra block copy (IBC) mode and an intra template matching (IntraTMP) mode is received.

At (S1220), an intra prediction mode associated with a reference block of the current block can be determined. The reference block can be indicated by a block vector (BV) of the current block.

In an example, prediction mode information associated with at least one subblock in the reference block is obtained by checking the at least one subblock in a pre-defined order. The intra prediction mode associated with the reference block is determined according to the prediction mode information associated with the at least one subblock.

In an example, prediction mode information associated with at least one subblock in the reference block that is located at one or more predefined subblock positions is obtained. The intra prediction mode associated with the reference block is determined according to the prediction mode information associated with the at least one subblock.

At (S1230), a transform set for the current block coded with the one of the IBC mode and the IntraTMP mode can be determined according to the intra prediction mode associated with the reference block.

At (S1240), an inverse transform can be performed on the current block according to the determined transform set.

Then, the process proceeds to (S1299) and terminates.

The process (1200) can be suitably adapted. Step(s) in the process (1200) can be modified and/or omitted. Additional step(s) can be added. Any suitable order of implementation can be used.

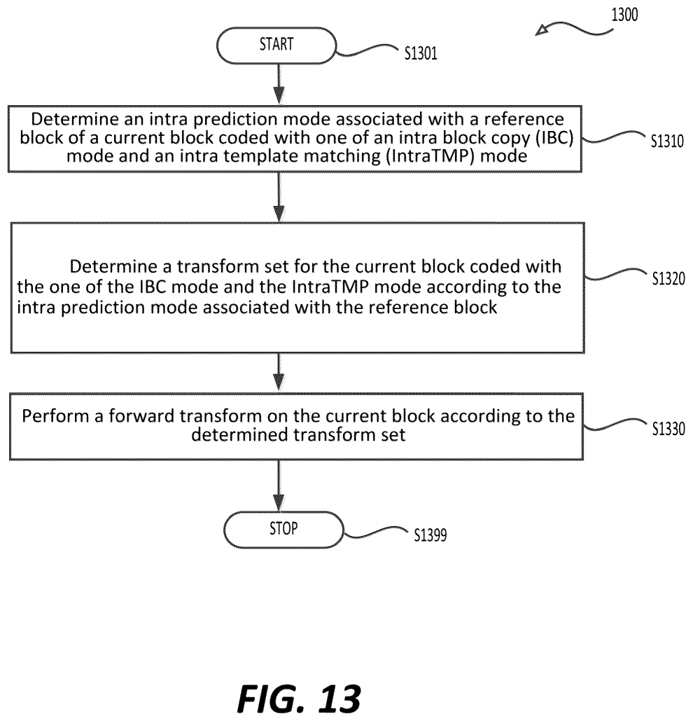

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), an intra prediction mode associated with a reference block of a current block coded with one of an intra block copy (IBC) mode and an intra template matching (IntraTMP) mode can be determined.

At (S1320), a transform set for the current block coded with the one of the IBC mode and the IntraTMP mode can be determined according to the intra prediction mode associated with the reference block.

At (S1330), a forward transform can be performed on the current block according to the determined transform set.

Then, the process proceeds to (S1399) and terminates.

The process (1300) can be suitably adapted. Step(s) in the process (1300) can be modified and/or omitted. Additional step(s) can be added. Any suitable order of implementation can be used.

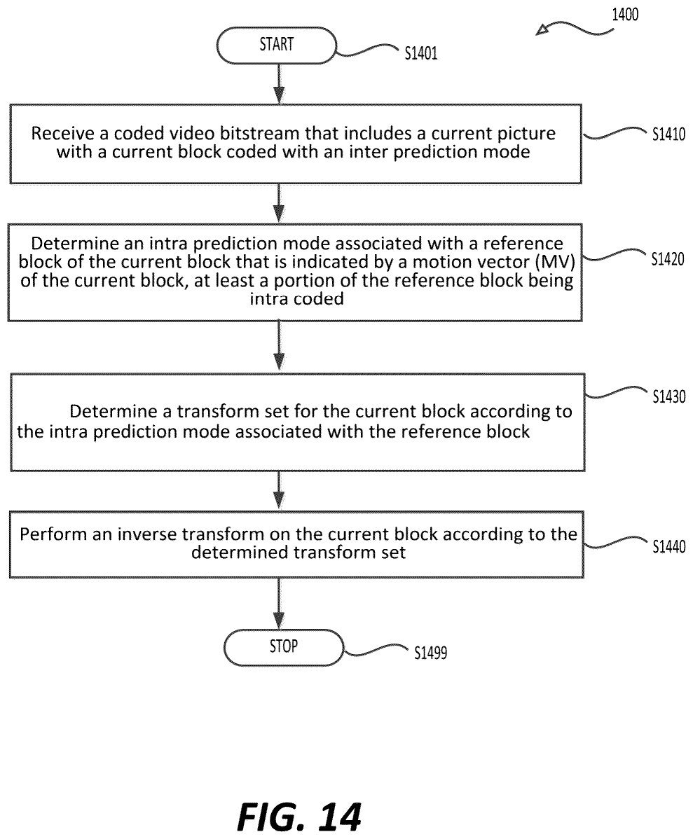

FIG. 14 shows a flow chart outlining a process (1400) according to an aspect of the disclosure. The process (1400) can be used in a video decoder. In various aspects, the process (1400) is executed by processing circuitry, such as the processing circuitry that performs functions of the video decoder (110), the processing circuitry that performs functions of the video decoder (210), and the like. In some aspects, the process (1400) is implemented in software instructions, thus when the processing circuitry executes the software instructions, the processing circuitry performs the process (1400). The process starts at (S1401) and proceeds to (S1410).

At (S1410), a coded video bitstream that includes a current picture with a current block coded with an inter prediction mode is received.

At (S1420), an intra prediction mode associated with a reference block of the current block that is indicated by a motion vector (MV) of the current block can be determined. At least a portion of the reference block is intra coded.

In an example, prediction mode information associated with at least one subblock in the reference block is obtained by checking the subblocks in a pre-defined order. The intra prediction mode associated with the reference block is determined according to the prediction mode information associated with the at least one subblock.

In an example, samples in subblocks in the reference block are coded in different intra prediction modes. Filtering can be applied to the subblocks to determine the intra prediction mode.

In an example, prediction mode information associated with at least one subblock in the reference block that is located at one or more predefined subblock positions is obtained. The intra prediction mode associated with the reference block is determined according to the prediction mode information associated with the at least one subblock.

At (S1430), a transform set for the current block can be determined according to the intra prediction mode associated with the reference block.

At (S1440), an inverse transform can be performed on the current block according to the determined transform set.

Then, the process proceeds to (S1499) and terminates.

The process (1400) can be suitably adapted. Step(s) in the process (1400) can be modified and/or omitted. Additional step(s) can be added. Any suitable order of implementation can be used.

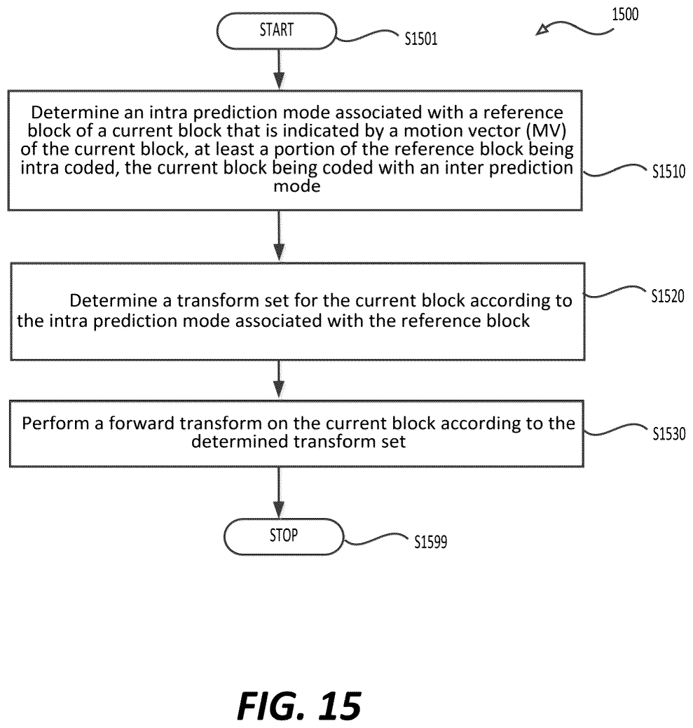

FIG. 15 shows a flow chart outlining a process (1500) according to an aspect of the disclosure. The process (1500) can be used in a video encoder. In various aspects, the process (1500) is executed by processing circuitry, such as the processing circuitry that performs functions of the video encoder (103), the processing circuitry that performs functions of the video encoder (303), and the like. In some aspects, the process (1500) is implemented in software instructions, thus when the processing circuitry executes the software instructions, the processing circuitry performs the process (1500). The process starts at (S1501) and proceeds to (S1510).

At (S1510), an intra prediction mode associated with a reference block of a current block that is indicated by a motion vector (MV) of the current block can be determined. At least a portion of the reference block is intra coded. The current block can be coded with an inter prediction mode.

At (S1520), a transform set for the current block can be determined according to the intra prediction mode associated with the reference block.

At (S1530), a forward transform can be performed on the current block according to the determined transform set.

Then, the process proceeds to (S1599) and terminates.

The process (1500) can be suitably adapted. Step(s) in the process (1500) can be modified and/or omitted. Additional step(s) can be added. Any suitable order of implementation can be used.

Aspects and/or examples in the disclosure may be used separately or combined in any order. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

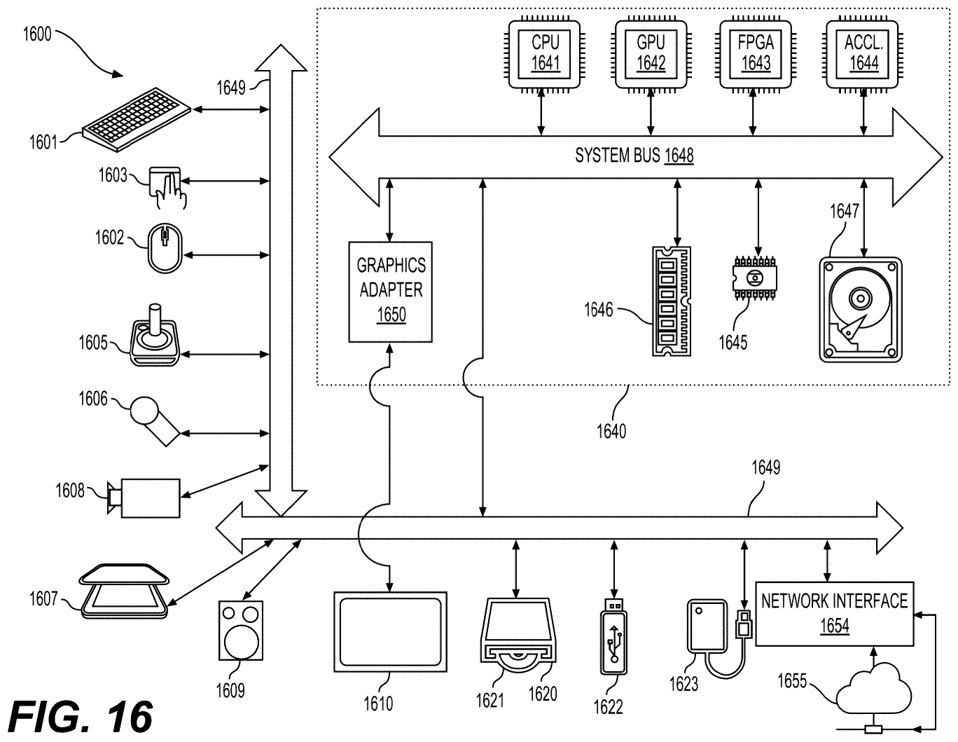

The techniques described above, can be implemented as computer software using computer-readable instructions and physically stored in one or more computer-readable media. For example, FIG. 16 shows a computer system (1600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 16 for computer system (1600) are exemplary in nature and are not intended to suggest any limitation as to the scope of use or functionality of the computer software implementing aspects of the present disclosure. Neither should the configuration of components be interpreted as having any dependency or requirement relating to any one or combination of components illustrated in the exemplary aspect of a computer system (1600).

Computer system (1600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1601), mouse (1602), trackpad (1603), touch screen (1610), data-glove (not shown), joystick (1605), microphone (1606), scanner (1607), camera (1608).

Computer system (1600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1610), data-glove (not shown), or joystick (1605), but there can also be tactile feedback devices that do not serve as input devices), audio output devices (such as: speakers (1609), headphones (not depicted)), visual output devices (such as screens (1610) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1600) can also include human accessible storage devices and their associated media such as optical media including CD/DVD ROM/RW (1620) with CD/DVD or the like media (1621), thumb-drive (1622), removable hard drive or solid state drive (1623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1600) can also include an interface (1654) to one or more communication networks (1655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1649) (such as, for example USB ports of the computer system (1600)); others are commonly integrated into the core of the computer system (1600) by attachment to a system bus as described below (for example Ethernet interface into a PC computer system or cellular network interface into a smartphone computer system). Using any of these networks, computer system (1600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1640) of the computer system (1600).

The core (1640) can include one or more Central Processing Units (CPU) (1641), Graphics Processing Units (GPU) (1642), specialized programmable processing units in the form of Field Programmable Gate Areas (FPGA) (1643), hardware accelerators for certain tasks (1644), graphics adapters (1650), and so forth. These devices, along with Read-only memory (ROM) (1645), Random-access memory (1646), internal mass storage such as internal non-user accessible hard drives, SSDs, and the like (1647), may be connected through a system bus (1648). In some computer systems, the system bus (1648) can be accessible in the form of one or more physical plugs to enable extensions by additional CPUs, GPU, and the like. The peripheral devices can be attached either directly to the core's system bus (1648), or through a peripheral bus (1649). In an example, the screen (1610) can be connected to the graphics adapter (1650). Architectures for a peripheral bus include PCI, USB, and the like.

CPUs (1641), GPUs (1642), FPGAs (1643), and accelerators (1644) can execute certain instructions that, in combination, can make up the aforementioned computer code. That computer code can be stored in ROM (1645) or RAM (1646). Transitional data can be also be stored in RAM (1646), whereas permanent data can be stored for example, in the internal mass storage (1647). Fast storage and retrieve to any of the memory devices can be enabled through the use of cache memory, that can be closely associated with one or more CPU (1641), GPU (1642), mass storage (1647), ROM (1645), RAM (1646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1600), and specifically the core (1640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1640) that are of non-transitory nature, such as core-internal mass storage (1647) or ROM (1645). The software implementing various aspects of the present disclosure can be stored in such devices and executed by core (1640). A computer-readable medium can include one or more memory devices or chips, according to particular needs. The software can cause the core (1640) and specifically the processors therein (including CPU, GPU, FPGA, and the like) to execute particular processes or particular parts of particular processes described herein, including defining data structures stored in RAM (1646) and modifying such data structures according to the processes defined by the software. In addition or as an alternative, the computer system can provide functionality as a result of logic hardwired or otherwise embodied in a circuit (for example: accelerator (1644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, comprising:
receiving a coded video bitstream that includes a current picture including a current block coded with one of an intra block copy (IBC) mode and an intra template matching (IntraTMP) mode;
determining one of (i) an intra prediction mode based on reconstructed samples of the current picture and (ii) a content type of the reconstructed samples of the current picture;
determining a transform set for the current block coded with the one of the IBC mode and the IntraTMP mode, the transform set being determined as associated with the one of (i) the determined intra prediction mode and (ii) the determined content type; and
performing an inverse transform on the current block according to the determined transform set.

2. The method of claim 1, wherein the reconstructed samples include neighboring reconstructed samples of the current block.

3. The method of claim 2, wherein
the determining the one of (i) the intra prediction mode and (ii) the content type includes:
calculating frequencies of edge directions of the current block using the neighboring reconstructed samples of the current block; and
determining the intra prediction mode that is associated with the most frequently used edge direction in the edge directions; and
the determining the transform set includes determining the transform set for the current block that is associated with the determined intra prediction mode.

4. The method of claim 2, wherein
the determining the one of (i) the intra prediction mode and (ii) the content type includes determining the one of (i) the intra prediction mode and (ii) the content type based on template-based intra mode derivation (TIMD):
calculating template matching costs between a current template including the neighboring reconstructed samples of the current block and respective templates of the current template that are indicated by candidate intra prediction modes; and
selecting a candidate intra prediction mode of the candidate intra prediction modes that is associated with the least template matching cost in the template matching costs as the determined intra prediction mode; and
the determining the transform set includes determining the transform set for the current block that is associated with the determined intra prediction mode.

5. The method of claim 1, wherein
the reconstructed samples in the current picture include reconstructed samples of a reference block that is indicated by a block vector of the current block;
the determining the one of (i) the intra prediction mode and (ii) the content type includes determining the one of (i) the intra prediction mode and (ii) the content type based on decoder-side intra mode derivation (DIMD):
calculating frequencies of directions of the reconstructed samples in the reference block; and
determining the intra prediction mode that is associated with the most frequently used direction in the directions; and
the determining the transform set includes determining the transform set for the current block that is associated with the determined intra prediction mode.

6. The method of claim 1, wherein
the determining the one of (i) the intra prediction mode and (ii) the content type includes determining the content type of one of reconstructed samples of a reference block and neighboring reconstructed samples of the current block, the reference block being indicated by a block vector of the current block, the reconstructed samples in the current picture including the one of the reconstructed samples of the reference block and the neighboring reconstructed samples of the current block; and
the determining the transform set includes determining the transform set for the current block according to whether the determined content type is screen content.

7. The method of claim 6, wherein the determining the transform set comprises:
determining that the transform set is a first transform set based on the determined content type being the screen content; and
determining that the transform set is a second transform set based on the determined content type being non-screen content, the second transform set being different from the first transform set.

8. The method of claim 6, wherein the determining the content type comprises:
determining a number of color values of the one of the reconstructed samples of the reference block and the neighboring reconstructed samples of the current block; and
in response to the number of color values being less than a threshold of color values, determining the content type as the screen content.

9. The method of claim 8, wherein the color values of the one of the reconstructed samples of the reference block and the neighboring reconstructed samples of the current block are associated with a specific color component.

10. The method of claim 8, wherein the color values of the one of the reconstructed samples of the reference block and the neighboring reconstructed samples of the current block are associated with multiple color components.

11. The method of claim 1, wherein the determining the one of (i) the intra prediction mode and (ii) the content type and the determining the transform set are performed only in response to the current block being in an intra slice of the current picture.

12. The method of claim 1, wherein the determining the transform set comprises:
determining the transform set for the current block according to the determined intra prediction mode using a look-up table that maps intra prediction modes to transform sets.

13. The method of claim 12, wherein
the transform set for the current block is a secondary transform set; and
the mapping between the intra prediction modes indicated by mode numbers (IntraPredMode) and the transform sets including 4 low-frequency non-separable transform (LFNST) sets indicated by LFNST set indices 0 to 3 is shown in the look-up table below:

| IntraPredMode | LFNST set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

14. A method of video decoding, comprising:
receiving a coded video bitstream that includes a current picture including a current block coded with one of an intra block copy (IBC) mode and an intra template matching (IntraTMP) mode;
determining an intra prediction mode associated with a reference block of the current block, the reference block being indicated by a block vector (BV) of the current block used in the one of the IBC mode and the IntraTMP mode;
determining a transform set for the current block coded with the one of the IBC mode and the IntraTMP mode according to the intra prediction mode associated with the reference block; and
performing an inverse transform on the current block according to the determined transform set.

15. The method of claim 14, wherein the determining the intra prediction mode comprises:
obtaining prediction mode information associated with at least one subblock in the reference block by checking the at least one subblock in a pre-defined order; and
determining the intra prediction mode associated with the reference block according to the prediction mode information associated with the at least one subblock.

16. The method of claim 14, wherein the determining the intra prediction mode comprises:
obtaining prediction mode information associated with at least one subblock in the reference block that is located at one or more predefined subblock positions; and
determining the intra prediction mode associated with the reference block according to the prediction mode information associated with the at least one subblock.

17. A method of video decoding, comprising:
receiving a coded video bitstream that includes a current picture including a current block coded with an inter prediction mode;
determining an intra prediction mode associated with a reference block of the current block that is indicated by a motion vector (MV) of the current block, at least a portion of the reference block being coded for intra prediction;
determining a transform set for the current block according to the intra prediction mode associated with the reference block; and
performing an inverse transform on the current block according to the determined transform set.

18. The method of claim 17, wherein the determining the intra prediction mode comprises:
obtaining prediction mode information associated with at least one subblock in the reference block by checking the subblocks in a pre-defined order; and
determining the intra prediction mode associated with the reference block according to the prediction mode information associated with the at least one subblock.

19. The method of claim 17, wherein
samples in subblocks in the reference block are coded in different intra prediction modes; and
the determining the intra prediction mode includes applying filtering to the subblocks to determine the intra prediction mode.

20. The method of claim 17, wherein the determining the intra prediction mode comprises:
obtaining prediction mode information associated with at least one subblock in the reference block that is located at one or more predefined subblock positions; and
determining the intra prediction mode associated with the reference block according to the prediction mode information associated with the at least one subblock.
